(19) United States
(12) Patent Application Publication
(10) Pub. No.: US 2008/0072231 A1
(43) Pub. Date: Mar. 20, 2008

(54) Resource management apparatus

(75) Inventor: Hideki Yoshida, Tokyo (JP)

Correspondence Address: NIXON & VANDERHYE, PC, 901 NORTH GLEBE ROAD, 11TH FLOOR, ARLINGTON, VA, 22203, US

(73) Assignee: Kabushiki Kaisha Toshiba, Tokyo (JP)

(21) Appl. No.: 11/822,926

(22) Filed: Jul. 11, 2007

(30) Foreign Application Priority Data
Sep. 20, 2006 (JP) JP2006-254799

(51) Int. Cl. G06F 9/50

(52) U.S. Cl. 718/104

(57) ABSTRACT

A resource management apparatus has a plurality of resource bidding sections and a bidding management section. Each of the resource bidding sections is provided for a plurality of application programs respectively, and generates the bid price of a resource using information of a quality parameter indicating the quality of the resource adjusted so as to decrement the quality parameter when each application program is not allocated a necessary volume of the resource for executing the application program and increment the quality parameter when each application program is allocated the necessary volume of the resource for executing the application program. The bidding management section performs resource allocation processing using the bid prices generated in the plurality of resource bidding sections.

### RELATED APPLICATION(S)

The present disclosure relates to the subject matter contained in Japanese Patent Application No. 2006-254799 filed on Sep. 20, 2006, which is incorporated herein by reference in its entirety.

### FIELD

The present invention relates to a resource management apparatus and a program product for managing resources consumed or supplied within a predetermined unit time by each of application programs.

### BACKGROUND

Hitherto, a real time system provided with a sensor has been available. For example, in the transportation field of ships, airplanes and automobiles, a sensor information system for keeping track of the surrounding circumstances and presenting information concerning the circumstances to the user on a screen of a display is used. The sensor information system for a ship includes a plurality of sensors including a radar, a sonar, an infrared sensor, and a video camera. The sensor information system analyzes the signal of one or more of the sensors in response to each phase, recognizes the surrounding circumstances, and displays the recognition result on a screen. The information concerning the surrounding circumstances is useful for safe navigation of the transport such as a ship.

In the systems in the transportation field, the display screen must be updated within a predetermined time to inform the user of the information concerning the recognized the surrounding circumstances. If the user cannot instantly keep track of the surrounding circumstances, there is a danger leading to an accident such as a collision. Thus, the systems must be real-time systems and signal processing based on a sensor signal needs to be performed as real-time processing satisfying a predetermined time constraint.

Hitherto, in such a real-time system for performing signal processing of a plurality of sensor signals, it has been a common practice to process the signals in separate subsystems. The computer resources such as a central processing unit (CPU) required for signal processing of each signal are provided separately for each subsystem and one real-time operating system (OS) is operated to be served for the subsystems, whereby the resources are allocated in subsystem units, so that design and development of a sensor information system satisfying a predetermined time constraint are facilitated.

However, in the mode in which separate subsystems are prepared for each signal, if overload occurs in one of the subsystems in charge of processing one signal or a failure occurs in one element of a subsystem, the subsystem cannot obey a predetermined time constraint on processing of the signal of which the subsystem is in charge or becomes impossible to perform processing, regardless of whether other subsystems still have margin in its computer resources.

Therefore, hitherto, it has been necessary for each of the subsystems to take a configuration having predetermined allowance for the function and the processing capability, so that the single subsystem can deal with such overload or a failure. However, since large hardware facilities become necessary to adopt such a configuration having allowance, the cost, the volume, and the power consumption of the facilities grow and a situation occurs in which commercial and technical feasibility of a sensor information system lowers.

Thus, in the transportation field regarding airplanes, there is a demand for configuring a sensor information system with comparatively small facilities by integrating signal processing of a plurality of signals into one computer system. Generally, such a system is implemented as a distributed system including a plurality of nodes each having one or more processors, memory, and input/output units, the nodes being joined by a network.

However, if processing of a plurality of signals is simply integrated into one system, when processing of a plurality of signals is performed, if a more important signal and a not much important signal exist in one aspect, it is feared that the time constraint on processing of the more important signal may also be affected because processing load of the not much important signal increases.

Theoretically, this problem can be resolved when the entire system is operated by one real time OS to perform real time overall scheduling. However, realistically, when a system that includes multiple processors is controlled by a single OS, the scheduling becomes very complicated so that the scheduling process requires some time period. Also, it is sometimes difficult to obtain a satisfactory function that satisfies the predetermined time constraint. Furthermore, as the even more serious problem, when nodes are connected by a network that does not guarantee the strict real time processing, the real time scheduling across the nodes is impossible in the first place.

Conventionally, a method for allocating resource through bidding has been researched as a method of executing resource allocation in a distributed system in a distributed manner. An example of such method is described in the following document.

Andrew Byde, Mathias Salle, and Claudio Bartolini “Market-Based Resource Allocation for Utility Data Centers”, HP Labs Technical Report HPL-2003-188, 2003

According to the resource allocation method through bidding, the resources, such as the CPU time, are allocated in a bidding for each unit time or for each task. Each of the application programs (hereinafter simply called “application”) makes a bid including a price and then requests for resource allocation, and the application making the highest price is determined to receive the resource allocation. The currency handled in the bidding is an indicator for quantifying how one application in one aspect is important for the user and is virtual currency which need not be linked to an actual currency. The resource allocation method through bidding is characterized by the fact that each module in a system behaves so as to maximize the profits resulting from subtracting payment currency from currency received by the module, whereby the efficiency of the whole system is improved.

Using the bidding method, resource allocation corresponding to the importance of a sensor signal for each aspect can be realized by allowing the application for performing processing of the important sensor signal to make a higher bid price. For each node, resource bidding processing of the node is performed, whereby the bidding processing can be performed in a distributed manner, so that distributed processing of resource allocation is easily performed.

In a simple model of resource allocation, only physical resources, such as the CPU time, are resources, OS and middleware programs are suppliers of resources, and application programs are consumers. In the actual system, however, more advanced and elaborate bidding may be executed based on a more complicated resource allocation model. Particularly, to execute resource allocation in a distributed system according to the bidding method, a more advanced resource allocation model called supply chain model may be used.

This model is a model imitating a supply chain in manufacturing and distribution industries. In the model, the concept of “producer” is introduced in addition to “suppliers” and “consumers”. The producer purchases resources from another party and produces resources to be sold for another party and not only the physical resources. In this model, data generated by the producer may also be handled as a resource in addition to a physical resource.

The concept of the producer is introduced, whereby distribution of processing into nodes and an application for performing preprocessing of data used by another application can be handled in a bidding. The supplier, the consumer, and the producer refer to module programs implemented as software in the system and do not refer to any natural person or any legal person.

Generally, in the bidding method using a supply chain model, how to determine the bid price becomes complicated as compared with the simple model mentioned above. An example of such method is described in the following document.

William E. Walsh and Michael P. Wellman “Efficiency and Equilibrium in Task Allocation Economies with Hierarchical Dependencies”, in Proceedings of the Sixteenth International Joint Conference on Artificial Intelligence, 1999

Particularly, to determine the price of the resource to be sold, considering how much the resource required for producing the resource can be bought, the producer needs to perform the operation of canceling bidding if the sale price falls below the purchase price. Although a method of determining the bid price at a time using a complicated calculation expression is also available, the calculation amount is large and thus it is a common practice to repeat bidding of a plurality of rounds using a temporary price until the price converges.

A possible example of the bidding plan of a producer (how to determine the bid price) in the bidding method of a plurality of rounds is as follows: At the start, both resources to be sold and bought are sent out for bids at appropriate initial prices and the sale price and the purchase price are changed minutely depending on whether or not the resources to be sold and bought are successfully being bid. But if no profit can be made by the bid (namely, the sale price falls below the sum total of the purchase prices), the bidden is abandoned. As such rounds are repeated, the sale price and the purchase price of the resources rise to an appropriate level or the bidding is abandoned, leading to determination of the bid price.

The described bidding method is for the supply chain bidding. To generally call for complicated bids of not only the supply chain bidding, but also bidding of a plurality of goods in which a plurality of resources are allocated at the same time or concurrently, for example, bidding of a plurality of rounds often is conducted.

Data of profits of the difference between the sale price and the purchase price may not be accumulated, but may be accumulated for use of the accumulation data as reference data to operation improvement of each application by the system administrator or the application.

However, if the amount of the target data to be processed by each application in the system is a fixed value, the amount of the resources used by each application is also determined a fixed value. For example, if the amount of the data processed by one application is constant, namely, is a fixed value, the CPU usage rate required for the application to process the fixed amount of the data also becomes constant, namely, is a fixed value.

To allocate resources to a plurality of applications according to the bidding method in such a system, the value set by the user for each application, namely, the user value is set in accordance with the importance of each application, whereby the user of the system can guarantee execution of the application recognized to be important by him or her, namely, high in the user value. The user value can be determined by the upper limit value (upper limit price) of the bid price of each application set by the user, for example. That is, the application with the upper limit price being high can present a higher price than other applications at the bidding time and thus the possibility that finally the resource can be being contracted by the application becomes high. Therefore, it can be said that the application with the upper limit price set high is an application high in the user value.

In contrast, some of the applications which are consumers (applications only buying resources) are not recognized to be important by the user and have a relatively low upper limit value of the bid price (is low in the user value) and thus may be unable to contract the bid and unable to operate in one situation (for example, when the resource price rises).

When the price of the resource to be consumed rises, an application of a producer (application buying a resource and selling the resource) can shift to price in such a manner that the price of the provided resource is raised. However, if the importance of the consumer for consuming the resource provided by the producer is low (the consumer (application) is low in the user value), the price of the provided resource cannot be raised in response to the rise in the price of the resource to be consumed and after all, the application of the producer cannot contract the bid and may be unable to operate.

### SUMMARY

It is therefore one of objects of the present invention to provide a resource management apparatus for executing resource allocation so as to enable even an application low in the user value or even an application of a producer with an application low in the user value as a consumer to contract the bid for the resource.

According to a first aspect of the invention, there is provided a resource management apparatus including: a storage that stores quality parameters being set for each of a plurality of application programs respectively, each of the quality parameters indicating a quality of a resource to be consumed or supplied by each of the application programs within a predetermined unit time; a plurality of resource bidders that are provided for each of the plurality of application programs respectively, each of the resource bidders including: a generation part that generates a bid price of the resource to be consumed or supplied in response to a volume of the resource to be consumed or supplied; and an update part that changes the bid price of the resource to be consumed or supplied using information of the quality parameter being adjusted to decrement by a first predetermined amount when each of the application programs is not allocated with a necessary volume of the resource for executing the application program, and to increment by a second predetermined amount when each of the application programs is allocated with the necessary volume of the resource for executing the application program; a parameter updater that updates the quality parameter stored in the storage to the adjusted quality parameter when the quality parameter is decremented by the first predetermined value or is incremented by the second predetermined value; and a bidding manager that performs resource allocation processing for allocating the resources to each of the application programs in the predetermined unit time using the bid prices generated by each of the resource bidders.

According to a second aspect of the invention, there is provided a computer readable medium storing a program causing a computer to execute a process for managing resources to be consumed or supplied by each of a plurality of application programs. The process includes: generating a bid price of a resource to be consumed or supplied by each of the application programs within a predetermined unit time in response to a volume of the resource to be consumed or supplied, for each of the application programs; changing the bid price of the resource to be consumed or supplied using information of a quality parameter that indicating the quality of the resource to be consumed or supplied by each of the application programs, the quality parameter being adjusted to decrement by a first predetermined amount when each of the application programs is not allocated with a necessary volume of the resource for executing the application program, and to increment by a second predetermined amount when each of the application programs is allocated with the necessary volume of the resource for executing the application program; updating the quality parameter to the adjusted quality parameter when the quality parameter is decremented by the first predetermined value or is incremented by the second predetermined value; and performing resource allocation processing for allocating the resources to each of the application programs in the predetermined unit time using the bid prices generated for each of the application programs.

According to a third aspect of the invention, there is provided an information processing apparatus for managing resources to be consumed or supplied by each of a plurality of application programs. The apparatus includes: a memory that stores quality parameters being set for each of a plurality of application programs respectively, each of the quality parameters indicating a quality of a resource to be consumed or supplied by each of the application programs within a predetermined unit time; and a processor that is operable to perform a process. The process includes: generating a bid price of the resource to be consumed or supplied in response to a volume of the resource to be consumed or supplied, for each of the application programs; changing the bid price of the resource to be consumed or supplied using information of the quality parameter being adjusted to decrement by a first predetermined amount when each of the application programs is not allocated with a necessary volume of the resource for executing the application program, and to increment by a second predetermined amount when each of the application programs is allocated with the necessary volume of the resource for executing the application program; updating the quality parameter to the adjusted quality parameter when the quality parameter is decremented by the first predetermined value or is incremented by the second predetermined value; and performing resource allocation processing for allocating the resources to each of the application programs in the predetermined unit time using the bid prices generated for each of the application programs.

### BRIEF DESCRIPTION OF THE DRAWINGS

In the accompanying drawings:

FIG. 1 is a block diagram to show the configuration of a sensor information processing system according to an embodiment of the present invention;

FIG. 2 is a block diagram to describe the portion of resource management in the software configuration of two nodes;

FIG. 3 is a block diagram to describe the relationship between resource supply and consumption according to the embodiment;

FIG. 4 is a block diagram to show the configurations of a resource bidding section and a bidding management section included in a resource management apparatus;

FIG. 5 is a flowchart to show an example of a processing flow of a bid price calculation section of a supplier;

FIG. 6 is a flowchart to show an example of a processing flow of a bid price calculation section about the resource supplied by a producer;

FIG. 7 is a flowchart to show an example of a processing flow of a bid price calculation section of a consumer;

FIG. 8 is a drawing to describe that bidding processing is performed only a predetermined number of times under the control of a round repetition management section;

FIG. 9 is a drawing to describe processing unit time;

FIG. 10 is a drawing to show an example of bidding information of physical resource;

FIG. 11 is a drawing to show an example of bidding information of data;

FIG. 12 is a flowchart to show an example of a processing flow of a successful bidder determination section of a physical resource manager of a supplier;

FIG. 13 is a flowchart to show an example of a processing flow of a successful bidder determination section of an information display application;

FIG. 14 is a flowchart to show an example of a processing flow of the round repetition management section;

FIG. 15 is a table to show an example wherein the bidding and contract volumes and prices of the CPU usage rate change with the passage of rounds; and

FIG. 16 is a table to show an example wherein the bidding and contract volumes and prices of data change with the passage of rounds.

### DETAILED DESCRIPTION OF THE EMBODIMENTS

An embodiment of the invention will be discussed with reference to the accompanying drawings.

### 1. Hardware Configuration of System

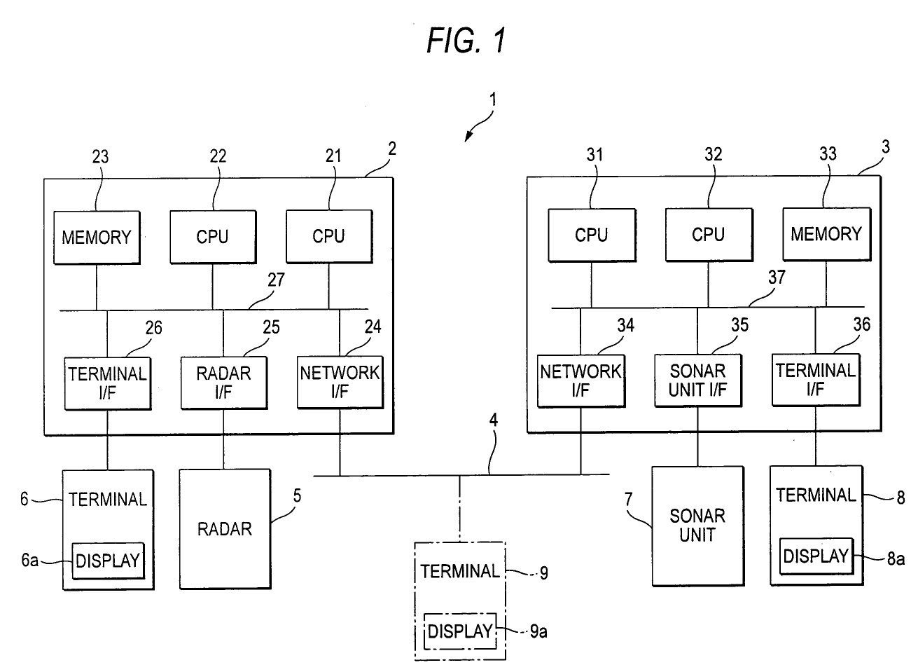

First, a hardware configuration of a system according to the embodiment of the invention will be discussed with reference to FIG. 1. FIG. 1 is a block diagram to show the configuration of a computer system for performing sensor information processing according to the embodiment (which will be hereinafter referred to as sensor information system 1). The sensor information system 1 according to the embodiment is employed for, for example, a ship or an airplane. Here, the sensor information system 1 is a system for informing a crew (user) of the surrounding circumstances as sensor information based on sensor signals from a laser and a sonar unit. The sensor information system 1 informs a crew, when a particular and dangerous obstacle is detected, of sensor information by displaying the sensor information on a screen, instantly, namely, within a predetermined time since detection of the obstacle. The real-time system refers to a system of executing predetermined processing within a predetermined time, for example, executing display processing of predetermined sensor information on a screen of a display within one second as the predetermined time since detection of a sensor signal.

The sensor information system 1 includes a plurality of nodes, here, two nodes 2 and 3 connected through a network 4. A radar 5 and a terminal 6 are connected to the node 2. The node 2 is a computer for performing predetermined signal processing and displaying the result of the signal processing on a screen of a display 6a of the terminal 6. The node 2 contains a signal processing application program for performing predetermined signal processing based on signals of the radar 5 and a sonar unit 7 (hereinafter, the application program may be simply called application) and an information display application program for displaying the result of signal processing concerning the signal of the radar 5 on the display 6a, as described later.

The sonar unit 7 and a terminal 8 are connected to the node 3. The node 3 is a computer for performing predetermined signal processing and displaying the result of the signal processing on a screen of a display 8a of the terminal 8. The node 3 contains a signal processing application program for performing predetermined signal processing based on signals of the sonar unit 7 and the radar 5 and an information display application program for displaying the result of signal processing concerning the signal of the sonar unit 7 on the display 8a, as described later.

The sensor signal of the radar 5 is transmitted to the node 3 through the network 4 and the sensor signal of the sonar unit 7 is also transmitted to the node 2 through the network 4, as described later.

The node 2 can display radar information on the screen of the display 6a of the terminal 6 and can present information concerning the sensor signal of the radar 5 to the user in real time. Likewise, the node 3 can display sonar information on the screen of the display 8a of the terminal 8 and can present information concerning the sensor signal of the sonar unit 7 to the user in real time.

Therefore, in the embodiment, information processing of the sensor information from the two sensors of the radar 5 and the sonar unit 7 is performed in the two nodes 2 and 3 and radar information and sonar information of the processing result are displayed on the screens of the displays 6a and 8a of the terminals 6 and 8 in real time. For example, for a ship, if the radar 5 detects an obstacle, position information, etc., of the obstacle is displayed on the screen as sensor information in real time. In the nodes 2 and 3, information processing of sensor information is performed in response to QoS (Quality of Service), as described later. The information processing of the sensor information from the two sensors of the radar 5 and the sonar unit 7 is processing to which a technique of QoS adaptation can be applied. The QoS is described later in detail.

The node 2 includes two central processing units (CPUs) 21 and 22, memory 23, a network interface (network I/F) 24, a radar interface (radar I/F) 25, and a terminal interface (terminal I/F) 26, which are connected through a bus 27.

Likewise, the node 3 includes two CPUs 31 and 32, memory 33, a network I/F 34, a sonar unit interface (sonar unit I/F) 35, and a terminal I/F 36, which are connected through a bus 37.

The bus 27, 37 may be wiring between boards of each node or on the board or may be wiring in the chip.

The network I/F 24 and 34 are interfaces for connecting the nodes 2 and 3 to the network 4. The terminal I/F 26 and 36 are interfaces for connecting the nodes 2 and 3 to the terminals 6 and 8. The node 2 and the radar 5 are connected through the radar I/F 25. The node 3 and the sonar unit 7 are connected through the sonar unit I/F 35.

The network 4 may be a network whose real-time property is guaranteed or may be a network whose real-time property is not guaranteed such as Ethernet (registered trademark).

In FIG. 1, the radar 5 and the sonar unit 7 are connected to the nodes 2 and 3 through the interfaces, but may each contain a network interface for direct connection to the network 4. In this case, the signals from the radar 5 and the sonar unit 7 are transmitted through the network 4 to the nodes 2 and 3.

Further, in the description given above, the terminals 6 and 8 are connected to the nodes 2 and 3, but another terminal 9 connected to the network 4 may be provided in place of or in addition to the terminals 6 and 8 as indicated by the alternate long and short dash line in FIG. 1. To provide the terminal 9 in place of the terminals 6 and 8, radar information and sonar information may be displayed on a display 9a of the terminal 9 or to provide the terminal 9 in addition to the terminals 6 and 8, radar information and sonar information may be displayed only on the display 9a of the terminal 9 or may be displayed on the display 9a of the terminal 9 as well as the displays 6a and 8a.

In the sensor information system 1, one or more terminals including a display and a keyboard exist and are connected to one of the nodes.

### 2. Software Configuration of System

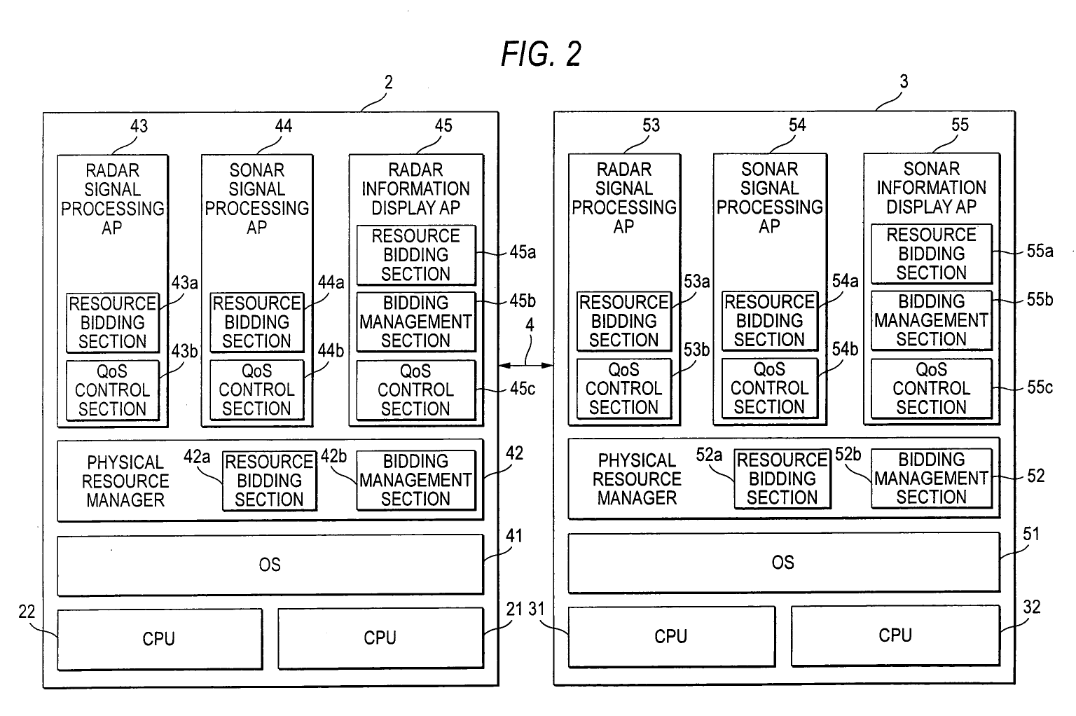

Next, the software configuration of the nodes 2 and 3 will be discussed based on FIG. 2. FIG. 2 is a block diagram to describe the portion of resource management of the software configuration in the nodes 2 and 3.

The nodes 2 and 3 are application execution apparatus for executing signal processing of a radar signal and a sonar signal and display processing of radar information display or sonar information display; they are also resource management apparatus for managing the resources of the CPU time, etc. That is, the nodes 2 and 3 perform signal processing based on a radar signal and a sonar signal and perform sensor information processing of displaying the processing result on the displays 6a and 8a of the terminals 6 and 8 in real time as radar information or sonar information and also perform resource management for such real-time sensor information processing. In this sense, the nodes 2 and 3 form resource management apparatus and the resource management apparatus are computers implemented mainly as software programs operating for executing the application programs on each node.

In node 2, one OS 41 operates on the two CPUs 21 and 22 of hardware. The OS 41 is a multiprocessor-compatible OS and is an OS such as Windows Operating System (registered trademark) or Linux, for example. A physical resource manager 42 is provided on the OS 41 for managing the CPU time as the resource.

Three application programs of a radar signal processing application 43 of a radar signal processing section, a sonar signal processing application 44 of a sonar signal processing section, and a radar information display application 45 of a radar information display section operate on the OS 41 through the physical resource manager 42.

Also in node 3, one OS 51 operates on the two CPUs 31 and 32 of hardware. The OS 51 is also a multiprocessor-compatible OS. A physical resource manager 52 is provided on the OS 51 for managing the CPU time as the resource.

Three application programs of a radar signal processing application 53, a sonar signal processing application 54, and a sonar information display application 55 operate on the OS 51 through the physical resource manager 52.

To execute each application program, the physical resource manager 42, 52 performs predetermined processing for bidding from each application and manages the CPU time so as to allow each application to execute processing for the time as much as the CPU time being contracted by the application, as described later.

In each node in which the resource management apparatus operates, one OS 41, 51 manages the software and the hardware. In the embodiment, each node contains two CPUs; if one node contains a plurality of CPUs, one multiprocessor-compatible OS operates and manages the whole resources of each node. Physical resources are managed by the physical resource manager implemented as middleware operating on each OS. The physical resource manager may be implemented as a function in the OS.

The resource management apparatus includes a plurality of resource bidding sections, a plurality of bidding management sections, and a plurality of QoS control sections. Specifically, in the node 2, the physical resource manager 42 has a resource bidding section 42a and a bidding management section 42b. The radar signal processing application 43 includes a resource bidding section 43a and a QoS control section 43b. The sonar signal processing application 44 includes a resource bidding section 44a and a QoS control section 44b. The radar information display application 45 has a resource bidding section 45a, a bidding management section 45b, and a QoS control section 45c. Likewise, in the node 3, the physical resource manager 52 has a resource bidding section 52a and a bidding management section 52b. The radar signal processing application 53 includes a resource bidding section 53a and a QoS control section 53b. The sonar signal processing application 54 includes a resource bidding section 54a and a QoS control section 54b. The sonar information display application 55 has a resource bidding section 55a, a bidding management section 55b, and a QoS control section 55c.

That is, the resource bidding sections 42a43a52a53aetc., are provided in the processing sections of modules for supplying or consuming resources (here, the physical resource managers 42 and 52, the applications 43 and 44, etc.,).

Only some applications may be provided with a resource bidding section. For example, an application not much consuming resources is not provided with a resource bidding section to skip participation in bidding; whereas, only an application much consuming resources is provided with a resource bidding section. In this case, the resources consumed by the applications not taking part in bidding need to be allocated fixedly in such a manner that a margin is provided to some extent.

On the other hand, one or more bidding management sections may be provided as a whole for each node. The bidding management section may be implemented as independent middleware or a function in the OS or may be provided in any processing section. Generally, when one supplier and two or more consumers exist, providing the bidding management section in the supplier simplifies processing and communications at the bidding time. When two or more suppliers and one consumer exist, providing the bidding management section in the consumer simplifies processing and communications at the bidding time. Then, in the embodiment, the physical resource manager (supplier) only supplies the CPU usage rate to a plurality of applications (consumers) and therefore the bidding management sections 42b and 52b are provided in the physical resource managers 42 and 52. Since each sensor information display application (consumer) only receives the CPU usage rate and sensor information from a plurality of applications (supplier and producer), the bidding management section 45b, 55b is provided in the sensor information display application. For example, in the node 2, the bidding management section 42b is provided in the physical resource manager 42 and the bidding management section 45b is provided in the radar information display application 45.

The QoS control sections 43b, 53b, 44b, 54b, 45c, and 55c are provided in the radar signal processing applications 43 and 53, the sonar signal processing applications 44 and 54, the radar information display application 45, and the sonar information display application 55 respectively. In each of the applications, information processing of sensor information is performed in response to QoS. The operation of the QoS control sections 43b, 53b, 44b, 54b, 45c, and 55c is described later.

### 3. Supply and Consumption of Resources

### 3.1 Resources

The resources will be discussed. The embodiment is an example based on a supply chain model in which not only the CPU usage rate which is a physical resource, but also data generated by an application program is handled as resources.

The reason why data is also handled as resources is as follows: Since the signal processing sections of sensor signals and the information display sections of sensor information are separated, if sensor information is not handled as a resource and only the CPU usage rate is handled as a resource, it is feared that resource allocation may be conducted ignoring the sensor information supply and consumption relationship. For example, a situation can occur in which the CPU usage rate is allocated to the sonar signal processing section 44, 54 for execution, but not allocated to the sonar information display application 55 and execution is impossible. In this case, a state in which the CPU is wasted to generate unused sensor information occurs. To make it possible to separate each signal processing section and each information display section while preventing such a state from occurring, not only the CPU usage rate, but also data is handled as resources.

The CPU usage rate is percentage (%) of using the CPU by the application per unit processing time described later. For example, if the unit processing time is one second and the CPU usage rate is 30%, it means that the application can use the CPU for as much time as 300 ms. In the embodiment, the CPU usage rate (%) is used, but the CPU use time (ms, etc.,) may be used. In the embodiment, data is radar information and sonar information.

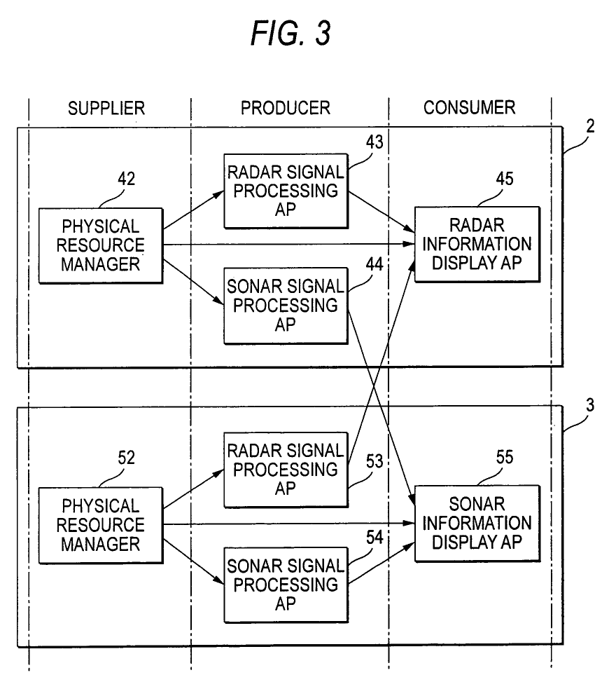

FIG. 3 is a block diagram to describe the relationship between resource supply and consumption according to the embodiment.

As shown in FIG. 3, in the supply chain model of the embodiment, the physical resource managers 42 and 52 correspond to suppliers, the radar signal processing applications 43 and 53 and the sonar signal processing applications 44 and 54 correspond to producers, and the radar information display application 45 and the sonar information display application 55 correspond to consumers.

The physical resource manager 42, 52 of the supplier for only supplying resources is middleware for managing the CPU usage rate of the physical resource. The physical resource manager 42, 52 may be built in the OS as a part of the OS.

The CPU usage rate is supplied from the physical resource manager 42, 52 of the supplier to each application. In FIG. 3, the CPU usage rate is supplied from the physical resource manager 42 to the radar signal processing application 43, the sonar signal processing application 44, and the radar information display application 45. The CPU usage rate is supplied from the physical resource manager 52 to the radar signal processing application 53, the sonar signal processing application 54, and the sonar information display application 55.

Each of the radar signal processing applications 43 and 53 and the sonar signal processing applications 44 and 54 of the producers consumes the CPU usage rate to generate predetermined sensor information from the sensor signal of the sensor and supplies the sensor information to the radar information display application 45 and the sonar information display application 55. That is, the sensor signal processing applications are producers for supplying the sensor information.

The radar information display application 45 and the sonar information display application 55 of the consumers only consume the CPU usage rate and the sensor information and do not supply resources to other applications. That is, the information display applications are consumers only consuming the CPU usage rate and the sensor information and not supplying resources to other applications.

Each processing section (application) operates only if all resources consumed by the application can be being contracted by the application. Each signal processing section exists in the nodes 2 and 3 to distribute load between both the nodes; if only either one is executed, sensor information is generated. For example, the radar information display application 45 is executed if the CPU usage rate is allocated to the radar information display application 45 and radar information is supplied to the radar information display application 45 from either of the radar signal processing applications 43 and 53.

### 3.2 QoS

QoS used in the embodiment will be discussed.

In the embodiment, data resolution or data density (which will be hereinafter referred to as resolution) is used as one of indicators indicating the quality level of data. If the data resolution is high, the data quality level is high. Then, a parameter for representing the quality of data provided by each application is handled as QoS and each application is executed in response to QoS of the quality parameter.

Generally, QoS is short for quality of service; particularly in the network technology field, QoS is understood as technology of reserving a band for specific communications and guaranteeing given communication speed. For example, in communications of audio, a moving image, etc., if line congestion occurs, often the bit rate is lowered and the band is suppressed and it can be said that the bit rate is a kind of QoS.

QoS adaptation generally is a technique of operating system elements in response to an increase or a decrease in the resource amount by raising or lowering the quality of service (QoS) in response to the amount of the resources that can be used by the system elements in one situation. Therefore, QoS refers to a parameter such that higher quality would improve convenience of the user, but even low quality would able to provide a measure of convenience for the user.

Then, in the embodiment, the value of data resolution is used as QoS and the data resolution is raised or lowered within the allowable image quality range, whereby each application operates in response to an increase or a decrease in the CPU usage rate. The data resolution specifically is spatial resolution (numbers of vertical and horizontal pixels) and temporal resolution (the number of frames per unit time).

If the data resolution varies, the CPU usage rate also varies. Generally, the calculation time of signal processing grows more than the linear value of the data resolution and therefore, for example, if the data resolution is halved, the calculation time can be cut to a fraction of what it used to be.

In the embodiment, using the data resolution as QoS, QoS adaptation to the signal processing applications and the information display applications for handling data is conducted and the CPU usage rate is decreased, whereby the resources are allocated so that even an application low in the user value or the like can have the resources being contracted by the application while the quality of image data is maintained within the allowed limit.

In other words, QoS is increased or decreased in response to the amount of available resources (CPU usage rate) in each application, whereby the application can adapt to an increase or a decrease in the available CPU usage rate.

If the application is a consumer, processing for QoS adaptation becomes closed processing in the application; if the application is a producer, the processing result for QoS adaptation is reflected on the supplied resources, namely, data.

### 3.3 Supply Method of Resources

Next, supply of the resources will be discussed.

In supply of the resources, sensor information of data is supplied as the signal processing application actually supplies the sensor information to the sensor information display application. For example, the radar signal processing application 43 supplies radar information provided by performing signal processing to the radar information display application 45, thereby supplying the sensor information.

On the other hand, supply of the CPU usage rate is conceptual and is not explicitly transferred; when an application program is created, supply of the CPU usage rate is realized by creating the program so that the program is executed using the CPU only if the CPU usage rate can be being contracted by the program.

If the actual behavior of an application cannot be trusted because the application is created by a third party or for any other reason, the physical resource manager may check whether or not the application uses the CPU usage rate as much as actually being contracted by the application by monitoring the state of the OS, etc. In this case, if the application uses the CPU exceeding the CPU usage rate actually being contracted by the application, it is also possible to forcibly cause the application to obey to allocation of the CPU usage rate by forcibly terminating the application by interrupt processing.

The described resource allocation is conducted by bidding of the resource management apparatus.

### 3.4 Determination Method of Resource Allocation

(a) CPU Usage Rate

First, the determination method of the consumption volume and the supply volume of the CPU usage rate of the physical resource will be discussed. Each application calculates the CPU usage rate used by the application, namely, the consumption volume for each processing unit time and specifies or determines it. It may be determined as the application creator explicitly describes a numeric value or a calculation expression in the source code of the application or as the compiler may determine it at the compiling time. Further, it may be determined as each application conducts actual measurement by monitoring the state of the physical resource manager or the OS or the like when the application is executed, and estimates the future physical resource use amount from a measurement history.

Since the consumption volume of the CPU usage rate varies depending on QoS, it is necessary to specify or estimate in correspondence with the consumption volume of the CPU usage rate. For example, as described later, it may be specified in the function format with QoS as an argument or several values of pairs of QoS and the consumption volume of the CPU usage rate may be specified and the consumption volume of the CPU usage rate about QoS among them may be calculated by interpolation.

The physical resource manager calculates the supply volume of the resources that can be supplied to the applications. In the embodiment, the value resulting from subtracting a margin for the operation of the OS and the middleware and safety from the percentage to all use time of as many as the number of CPUs is the supply volume to the applications. In the embodiment, in each node, 180% resulting from subtracting a margin of 20% from 200% corresponding to two CPUs is set as the supply volume.

(b) Sensor Information

Next, the determination method of the consumption volume and the supply volume of sensor information will be discussed.

The consumption volume and the supply volume of sensor information of any other resource than the physical resource are specified as the application creator explicitly describes a numeric value or a calculation expression as a part of the logic of the application in the source code of the application.

For example, the sonar signal processing application receives a sensor signal in a predetermined sampling period from the sonar unit 7 of a sensor and thus the amount of the sensor signal (bit rate, etc.,) is constant, but the consumption volume of the sensor information changes in response to QoS. That is, although the amount of the sensor signal is constant, the amount of data processed by the sonar signal processing application changes in response to QoS. The sonar signal processing application performs predetermined signal processing and supplies image data of sensor information to the sonar information display application and thus the amount of the sensor information (bit rate, etc.,) becomes the supply volume.

Therefore, the consumption volume and the supply volume change based on bidding; in each node, the CPU usage rate also changes in response to the amount of the data processed in each node. For example, in the node 2, the amount of the processed sensor data changes in response to QoS and thus the CPU usage rate also changes in response to the changed sensor data amount. Likewise, in the node 3, the amount of the processed sensor data changes in response to QoS and thus the CPU usage rate also changes in response to the changed sensor data amount. For example, all amount of the sensor signal output from the radar 5 is shared between the nodes 2 and 3 and the CPU usage rate for processing the shared amount of the sensor signal in response to QoS becomes necessary in each node.

The signal processing application and the information display application capable of adapting to QoS are provided with QoS control section 108 as QoS control section, as described above. Upon reception of QoS from resource bidding section 102, the QoS control section 108 sends QoS (data resolution) to the signal processing application and the information display application for actually performing signal processing, and the signal processing application and the information display application control the operation based on QoS so as not to consume the resource exceeding the resource (CPU usage rate) that can be being contracted by the applications.

(c) Notification of Resource Allocation

Notification of the consumption volume or the supply volume determined or specified according to the described procedure in each processing section is sent to the resource bidding section provided in the processing section, and the resource bidding section submits a bid corresponding to the consumption volume or the supply volume to the bidding management section.

### 4. Configuration of Resource Management Apparatus

### 4.1 Resource Management Apparatus

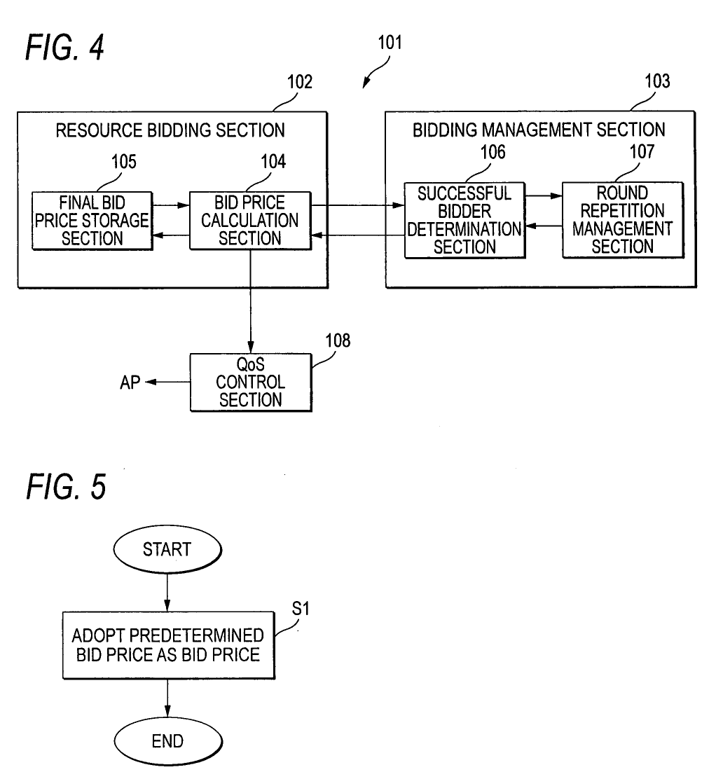

FIG. 4 is a block diagram to show the relationship among the resource bidding section, the bidding management section, and the QoS control section making up the resource management apparatus.

Resource management apparatus 101 in the embodiment includes a plurality of resource bidding sections 102, a plurality of bidding management sections 103, and a plurality of QoS control sections 108. FIG. 4 shows a flow of data among one resource bidding section 102, one bidding management section 103, and one QoS control section 108 to show the relationship between the resource bidding section 102 and the bidding management section 103 and the QoS control section 108 corresponding to the resource bidding section in each application.

The QoS control section 108 in FIG. 4 is provided in each of the radar signal processing applications 43 and 53, the sonar signal processing applications 44 and 54, the radar information display application 45, and the sonar information display application 55. Therefore, in bidding processing of the physical resource manager 42, 52 in which no QoS control section is involved, the QoS control section 108 in FIG. 4 does not exist and the resource bidding section 102 and the bidding management section 103 perform bidding processing.

For example, in the node 2, for the CPU usage rate, each of the resource bidding sections 42a43a44aand 45a corresponds to the resource bidding section 102 and the bidding management section 42b corresponds to the bidding management section 103. For data of radar information, each of the resource bidding sections 43a (and 53a) and 45a corresponds to the resource bidding section 102, the bidding management section 45b corresponds to the bidding management section 103, and each of the QoS control sections 43b (and 53b) and 45c corresponds to the QoS control section 108.

The resource bidding section 102 includes a bid price calculation section 104 and a final bid price storage section 105. The bidding management section 103 includes a successful bidder determination section 106 and a round repetition management section 107. When notification of bidding and bidding result is sent, information of the resource amount, QoS, and a unit price is provided.

Next, the details operation of the components of the resource management apparatus 101 will be discussed.

### 4.2 Resource Bidding Section

First, processing of the resource bidding section 102 will be discussed.

The resource bidding section 102 submits a bid for the resource of the consumption volume or the supply volume obtained by the above-described determination to the bidding management section 103, namely, provides information of the resource of the resource bidding section. For bidding, the resource bidding section submits a bid to the bidding management section more than once, namely, over a plurality of rounds.

In each round, the bid price calculation section 104 calculates the bid price as the bid price.

To calculate the bid price as the bid price, the price such that the profit of the processing section by buying or selling the resource at the price is maximized must be presented.

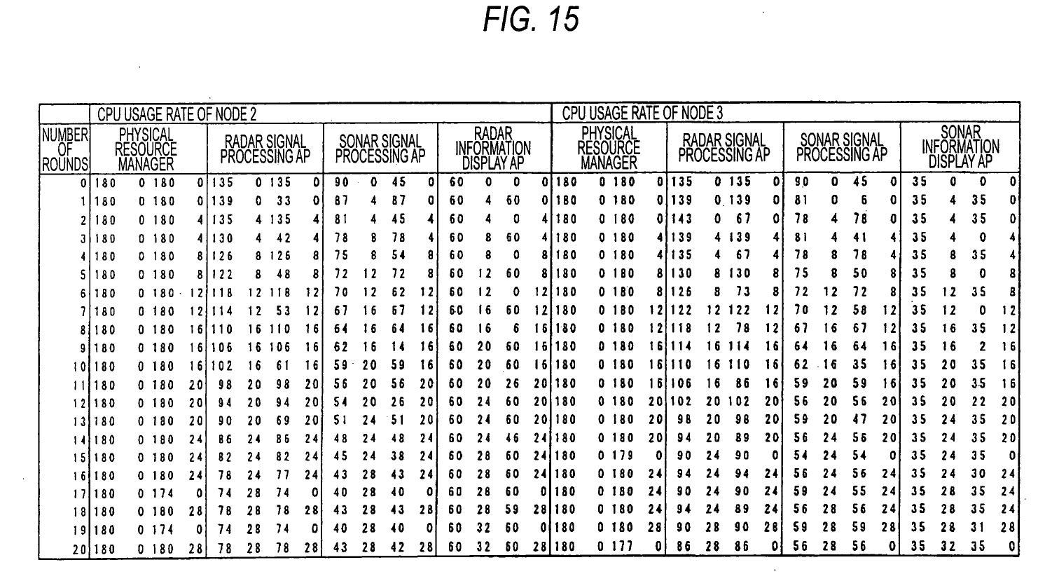

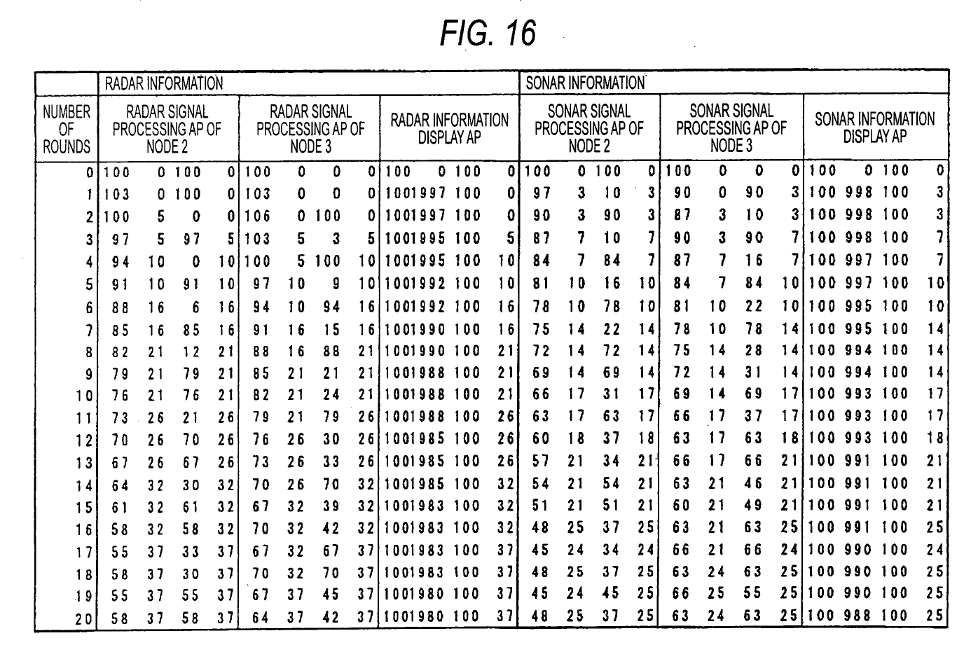

The specific operation of the bid price calculation section 104 varies depending on which of a supplier, a producer, or a consumer the processing section is. Each case will be discussed. FIGS. 15 and 16 are tables to show examples wherein the bidding and contract volumes and prices of the CPU usage rate and data change with the passage of rounds. FIG. 15 shows the bid volumes, the bid prices, the contract volumes, and the contract prices in the processing sections in the nodes 2 and 3 about the CPU usage rate. FIG. 16 shows the bid volumes, the bid prices, the contract volumes, and the contract prices in the processing sections about the data. The numerals arranged under the sections are the bid volume, the bid price, the contract volume, and the contract price from the left to the right. The specific operation of the bid price calculation section 104 will be discussed with reference to FIGS. 15 and 16.

(a) When Processing Section is Supplier

The supplier need not be reluctant to sell the resource that can be supplied by the supplier and thus may submit a bid so that the resource can be sold at the maximum regardless of the price. Therefore, the bid price calculation section 104 of the supplier may always return a fixed bid price. In the embodiment, it is assumed that the physical resource manager 42, 52 of the supplier always submits a bid for the CPU usage rate at price 0. Thus, for the supplier, the final bid price storage section may be omitted.

FIG. 5 is a flowchart to show an example of a processing flow of the bid price calculation section 104 of the supplier. The bid price calculation section 104 adopts a predetermined bid price, here, always adopts fixed “0,” for example, as the bid price (step S1).

(b) When Processing Section is Producer

If the resource can be sold at a high price, the producer may buy the resource at a high price to generate the resource; on the other hand, if the sale price falls below the purchase price, the producer needs to stop dealing trade. Thus, the bid price calculation section 104 of the producer performs the following processing:

The final bid price storage section 105 stores the bid price and QoS specified by application in the last round of the preceding bidding.

In the initial round, the bid price calculation section 104 adopts the values recorded in the final bid price storage section 105 as the bid price and QoS. In the final bid price storage section 105, 0 is recorded as the initial value of the bid price and the standard value (or the maximum value) of QoS is recorded. In the second or later round, the bid price calculation section 104 adjusts the bid price and QoS depending on whether or not a successful bid can be made in the preceding round.

About the resource supplied by the home section (for example, data of radar information if the home section is the radar signal processing application 43), the bid price calculation section 104 submits a bid by presenting the prediction value of the sum total of the bid prices (purchase prices) of the resource consumed by the home section (for example, the CPU usage rate if the home section is the radar signal processing application 43) as the bid price (purchase price). The prediction value of the bid price (purchase price) of the resource consumed by the home section is calculated according to a method of finding the sum total of the contract prices of the resource consumed by the home section in the preceding round (the contract price is not always the contract price of the processing section and if the processing section cannot contract the bid, the contract price is the contract price of any other processing section). If the resource consumed by the home section cannot be being contracted by the home section in the preceding round, the value is calculated according to a method of incrementing the resource bid price by a predetermined amount.

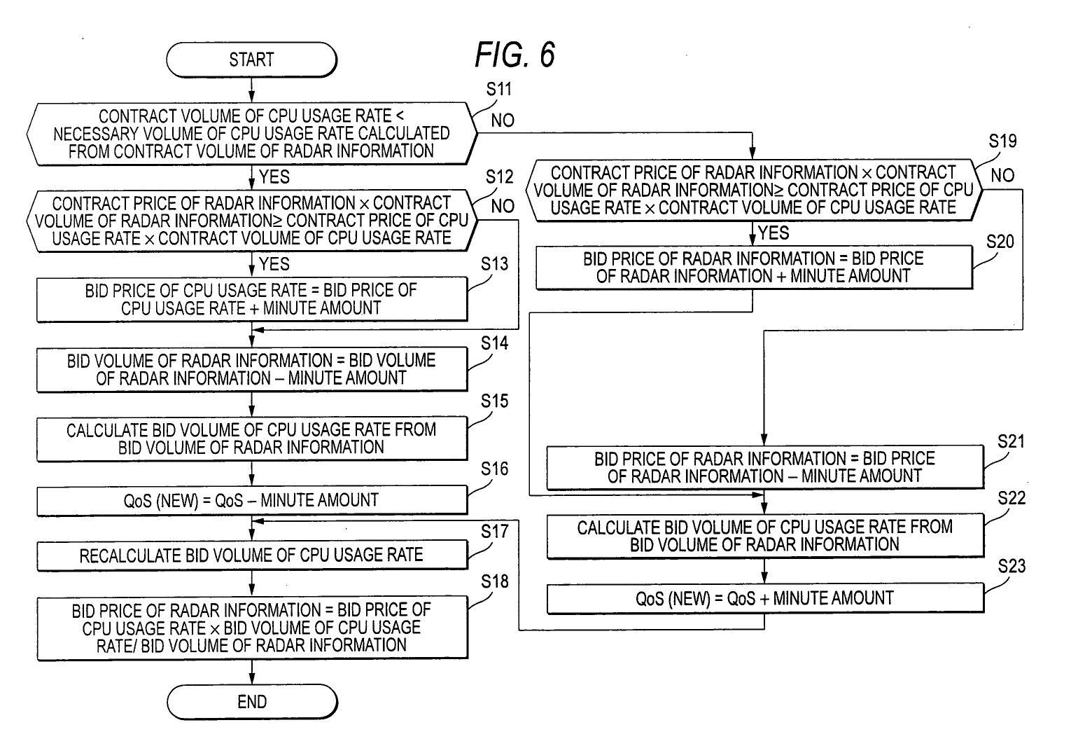

FIG. 6 is a flowchart to show an example of a processing flow of the bid price calculation section 104 about the resource supplied by the producer. The processing in FIG. 6 is executed by the radar signal processing application 43 just before each round starts in bidding processing, and the bid price and QoS are determined for each round. The determined bid price and QoS are supplied to the bidding management section 103.

First, the bid price calculation section 104 determines whether or not the preceding contract volume of the CPU usage rate is less than the necessary volume of the CPU usage rate calculated from the contract volume of radar information (step S11). If the contract volume of the CPU usage rate is less than the necessary volume of the CPU usage rate calculated from the contract volume of radar information, it means that the resource for executing the application is not allocated. If the contract volume of the CPU usage rate is less than the necessary volume of the CPU usage rate calculated from the contract volume of radar information, YES is returned at step S11 and the bid price calculation section 104 determines whether or not the product of the contract price of the radar information and the contract volume of the radar information is equal to or greater than the product of the contract price of the CPU usage rate and the contract volume of the CPU usage rate (step S12).

FIGS. 15 and 16 show an example wherein the radar signal processing application 43 requires the CPU usage rate “135” for generating “100” of radar information.

YES is returned at step S11 in the case where in round 5 of the radar signal processing application 43 in the node 2, the contract volume of the CPU usage rate is “48” in FIG. 15; while, the contract volume of the radar information is “91” in FIG. 16. In this case, the CPU usage rate calculated from the contract volume of the radar information “91” is “123” and the contract volume of the CPU usage rate is “48” or more.

If the product of the contract price of the radar information and the contract volume of the radar information is equal to or greater than the product of the contract price of the CPU usage rate and the contract volume of the CPU usage rate, YES is returned at step S12 and the process goes to step S13. If YES is returned at step S12, it means that the trade is profitable (namely, the sell price exceeds the purchase price). YES is returned at step S12 in the case where in round 19 of the radar signal processing application 43 in the node 2, the contract volume of the CPU usage rate is “74,” the contract price is “0,” and the product is “0” in FIG. 15; while, the contract volume of the radar information is “55,” the contract price is “37,” and the product is “2035” in FIG. 16, for example.

When YES is returned at step S12, the bid price of the CPU usage rate of the radar signal processing application 43 may be increased a little and therefore the bid price calculation section 104 increments the bid price of the CPU usage rate by a minute amount (d1) of a predetermined amount (step S13). Here, the incremental minute amount is “4.” In FIG. 15, the bid price is increased from “74” to “78” from round 19 to round 20 of the radar signal processing application 43 in the node 2.

If NO is returned at step S12, the bid price calculation section 104 decrements the bid price of the radar information by a minute amount (d2) of a predetermined amount (step S14) to decrease the bid volume of the radar information of the radar signal processing application 43. If NO is returned at step S12, it means that the trade is not profitable.

In round 18 of the radar signal processing application 43 in the node 2, the contract volume of the CPU usage rate is “78,” the contract price is “28,” and the product is “2184” as shown in FIG. 16. In contrast, the contract volume of the radar information is “30,” the contract price is “37,” and the product is “1110” in FIG. 16. In such a case, the radar signal processing application 43 decreases the bid volume of the radar information from “58” to “55” from round 18 to round 19.

The bid price calculation section 104 calculates changed CPU usage rate bid volume AQ from the bid volume of the radar information (step S15).

Next, the bid price calculation section 104 adjusts QoS so as to decrement QoS by a predetermined amount (step S16). Step S16 forms a parameter update section for updating QoS to adjusted QoS. If the image is a radar image and it is assumed that the radar image can take resolution in the range of the maximum value to a predetermined allowed limit value, current QoS is decremented by a predetermined minute amount toward the allowed limit value (minimum value) to calculate new QoS (new). For example, the initial resolution of the maximum value 1000 is decremented by a predetermined minute value of 50 to provide a new value 950. The allowed limit value is a value corresponding to the allowable image quality level for the user to use the image and is set by the user.

The bid price calculation section 104 uses the new QoS (new) to recalculate the bid volume of the CPU usage rate found by the calculation at step S15 (step S17). For example, predetermined computation processing, for example, processing of multiplying the bid volume AQ of the CPU usage rate found by the calculation at step S15 by the square of (QoS (new) /maximum value), for example, is performed, whereby new CPU usage rate bid volume AQ (new) can be calculated and found. The new CPU usage rate bid volume AQ (new) is stored in the bid price calculation section 104. In the above-described example, the bid volume AQ of the CPU usage rate is multiplied by the square value of (950/1000) (=0.9025) to find new CPU usage rate bid volume AQ (new).

The new Qos (new) information is supplied to the application (AP) as shown in FIG. 4 so that it is used in processing of the application.

The CPU usage rate found by the calculation at step S17 is the CPU usage rate required for generating radar information with low QoS.

The bid price calculation section 104 divides the product of the bid price and the bid volume of the CPU usage rate by the bid volume of the radar information, thereby calculating the bid price of the radar information (step S18). Therefore, steps S17 and S18 form a bid price change section for changing the resource bid price.

In other words, in bidding, when the CPU usage rate cannot be secured (YES at step S11) and the trade is profitable (YES at step S12), bidding processing is performed so that a successful bid for the resource can be made by not only increasing the bid price of the CPU usage rate (step S13), but also lowering the image resolution (step S16) for decreasing the bid volume of the CPU usage rate.

If NO is returned at step S11, namely, if the CPU usage rate required for processing radar information can be secured, the bid price calculation section 104 determines whether or not the product of the contract price of the radar information and the contract volume of the radar information is equal to or greater than the contract price of the CPU usage rate and the contract volume of the CPU usage rate (step S19).

NO is returned at step S11 in the case where in round 18 of the radar signal processing application 43 in the node 2, the contract volume of the CPU usage rate is “78” as shown in FIG. 15; while, the contract volume of the radar information is “30” as shown in FIG. 16. In this case, the necessary CPU usage rate corresponding to the contract volume of the radar information “30” is “41” and the contract volume of the CPU usage rate is less than “78”.

If YES is returned at step S19, namely, if the trade is profitable, the bid price calculation section 104 increments the bid price of the radar information by a minute amount (d3) of a predetermined amount (step S20) to increase the bid price of the radar information of the radar signal processing application 43.

If NO is returned at step S19, namely, if the trade is not profitable, the bid price calculation section 104 decrements the bid price of the radar information by a minute amount (d4) of a predetermined amount (step S21) to decrease the bid price of the radar information of the radar signal processing application 43.

Then, the bid price calculation section 104 calculates CPU usage rate bid volume AQ from the bid volume of the radar information (step S22). Next, the bid price calculation section 104 adjusts QoS so as to increment QoS by a predetermined amount (step S23). Step S23 forms a parameter update section for updating QoS to adjusted QoS. Current QoS is decremented by a predetermined minute amount to calculate new QoS (new). For example, resolution of 900 is incremented by a predetermined minute value of 50 to provide a new value 950.

The process proceeds to steps S17 and S18.

In other words, in bidding, when the CPU usage rate can be secured (NO at step S11) and the trade is profitable (YES at step S12), bidding processing is performed so as to raise the image resolution (step S23) for increasing the bid volume of the CPU usage rate.

(c) When Processing Section is Consumer

The consumer buys the resource consumed by the consumer within the range to the upper limit value of the purchase price corresponding to the importance of the application in the aspect, namely, the situation and performs processing operation. The importance of each application can be changed in response to the situation. The application creator may describe the upper limit value in the source code of the application, the application may recognize the aspect and calculate the upper limit value, or the user may directly or indirectly specify the upper limit value through the terminal.

In the embodiment, assuming that radar information is more important than sonar information, the upper limit value of the sum total of the purchase prices of the resources of the radar information display application is set to “200000” and the upper limit value of the sum total of the purchase prices of the resources of the sonar information display application is set to “100000.” If the resource cannot be bought within the range, resource purchase of the unit time is abandoned. Therefore, bidding on which the importance of a sensor signal is reflected is conducted.

In the initial round, the bid price calculation section 104 adopts the values recorded in the final bid price storage section 105 as the bid price and QoS. In the final bid price storage section 105, 0 is recorded as the initial value of the bid price and the standard value (or the maximum value) of QoS is recorded. In the second or later round, the bid price calculation section 104 adjusts the bid price and QoS depending on whether or not a successful bid can be made in the preceding round.

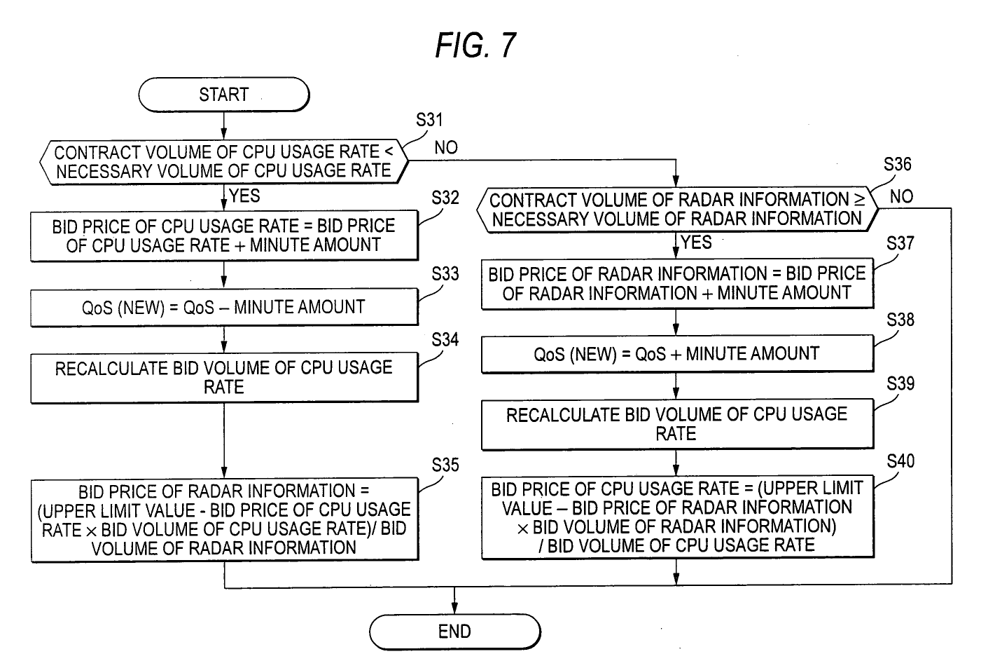

FIG. 7 is a flowchart to show an example of a processing flow of the bid price calculation section 104 of the consumer. First, the bid price calculation section 104 determines whether or not the contract volume of the CPU usage rate is less than the necessary volume of the CPU usage rate (step S31).

For example, in FIG. 15, the necessary volume of the CPU usage rate of the radar information display application in the node 2 is “60” and in FIG. 15, the contract volume is “60” as a result.

If YES is returned at step S31, namely, if the contract volume of the CPU usage rate is less than the necessary volume of the CPU usage rate, the bid price calculation section 104 increments the bid price of the CPU usage rate by a minute amount (d5) of a predetermined amount (step S32).

As at steps S16 and S17 in FIG. 6, the bid price calculation section 104 decrements QoS by a predetermined minute amount and recalculates the bid volume of the CPU usage rate responsive to the decremented QoS (new) (steps S33 and S34). The bid price calculation section 104 multiplies the bid price of the CPU usage rate by the bid volume of the CPU usage rate, subtracts the multiplication result from the upper limit value, and divides the subtraction result by the bid volume of the radar information to calculate the bid price of the radar information (step S35). That is, the bid price of the radar information is determined in the range in which the sum of the bid price of the CPU usage rate multiplied by the bid volume of the CPU usage rate and the bid price of the radar information multiplied by the bid volume of the radar information does not exceed the upper limit value.

If NO is returned at step S31, namely, if the contract volume of the CPU usage rate is equal to or greater than the necessary volume of the CPU usage rate, the bid price calculation section 104 determines whether or not the contract volume of the radar information is equal to or greater than the necessary volume of the radar information (step S36).

The necessary volume of the radar information is a value determined in response to QoS. For example, the necessary volume of the CPU usage rate of the radar information display application 45 in the node 2 is “100” and in FIG. 16, the contract volume is “100” as a result.

If YES is returned at step S36, namely, if the contract volume of the radar information is equal to or greater than the necessary volume of the radar information, the bid price calculation section 104 increments the bid price of the radar information by a minute amount (d6) of a predetermined amount (step S37). As a result of giving a higher bid price to the radar information, a lower bid price is given to the CPU usage rate.

As at steps S22 and S23 in FIG. 6, the bid price calculation section 104 increments QoS by a predetermined minute amount and recalculates the bid volume of the CPU usage rate responsive to the incremented QoS (new) (steps S38 and S39).

The bid price calculation section 104 multiplies the bid price of the radar information by the bid volume of the radar information, subtracts the multiplication result from the upper limit value, and divides the subtraction result by the bid price of the CPU usage rate to calculate the bid price of the CPU usage rate (step S40). That is, the bid price of the CPU usage rate is determined in the range in which the sum of the bid price of the CPU usage rate multiplied by the bid volume of the CPU usage rate and the bid price of the radar information multiplied by the bid volume of the radar information does not exceed the upper limit value.

### 4.3 Bidding Management Section

Next, processing of the bidding management section 103 will be discussed.

The bidding management section 103 determines which processing section makes a successful bid for the resource based on bidding, namely, bidding information from each resource bidding section 102, and sends the bidding result to the resource bidding section 102 of each processing section. The bidding result information contains information as to whether or not the processing section can contract the bid and information of the contract price (which is not always the contract price of the processing section and if the processing section cannot contract the bid, the contract price of any other processing section).

The resource bidding section 102 of each processing section receiving the bidding result information performs the operation for the processing unit time based on the result. The processing section that can finally make a bid for the resource to be consumed performs the operation consuming the resource. Usually, the processing section that cannot make a bid for all resources to be consumed in one processing unit time enters a sleep state without performing processing within the processing unit time. However, if the processing section can perform some operation although it could not make a contract for some of the resources to be consumed, the processing section performs the processing operation it can perform with the contracted resource. On the other hand, the processing section not making a successful bid for the resource that can be supplied does not supply the resource in the next processing unit time.

For the CPU usage rate which is a physical resource, when making a successful bid for the CPU usage rate, each application executes predetermined processing using the CPU for the time as much as the time obtained as the result of the successful bid in the next processing unit time. For data of any other resource than the physical resource, when making a successful bid for the data, each application performs processing of the data amount as much as the amount being contracted by the application.

For example, the radar signal processing application 43 executes data of the resolution corresponding to QoS contained in the bidding result information for the time as much as the CPU time obtained as the result of the successful bid. The radar information display application 45 executes processing of the data amount obtained as the result of the successful bid for the time as much as the CPU time obtained as the result of the successful bid in response to QoS only if both a successful bid for the CPU usage rate and a successful bid for data amount (a successful bid from either the radar signal processing application 43 or 53) are made, as described above.

(a) Round Management

Rounds will be discussed.

In the embodiment, the number of rounds, namely, the number of repetitions is a bidding abort condition. That is, management is executed so that bidding processing is not performed exceeding the predetermined number of rounds. That is, the round repetition management section 107 of the bidding management section 103 counts the number of rounds in each processing unit time and processing is monitored so as to determine a successful bidder only a predetermined number of times.

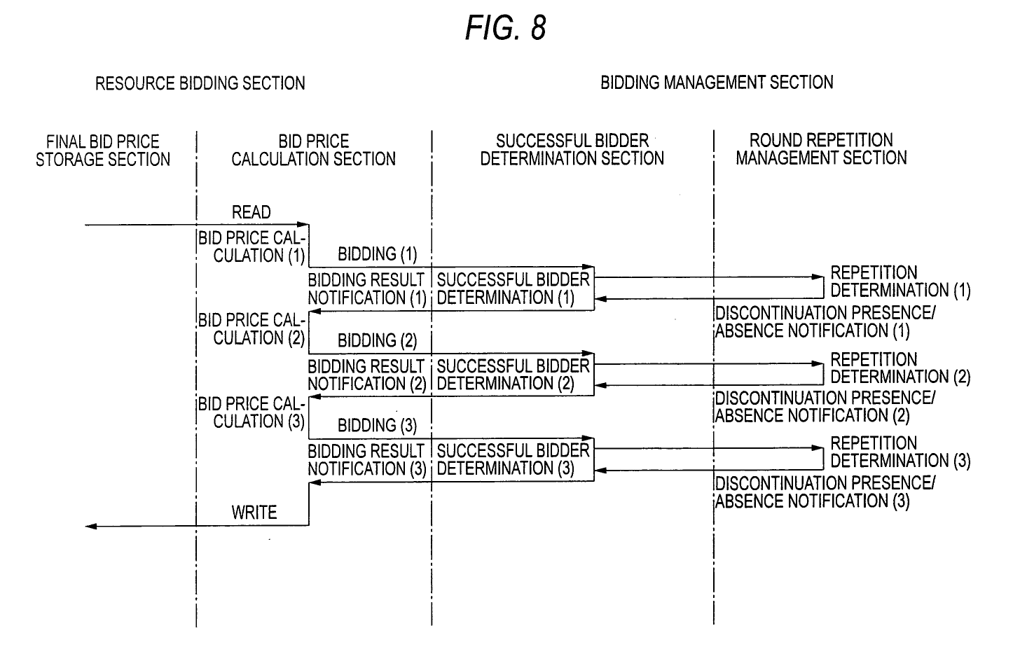

FIG. 8 is a drawing to describe that bidding processing is performed only a predetermined number of times under the control of the round repetition management section 107.

As shown in FIG. 8, the resource bidding section 102 first reads the preceding final bid price from the final bid price storage section 105, calculates the bid price using the final bid price, and submits a bid (bidding (1)). The bidding management section 103 performs successful bid processing for the bidding and determines a successful bidder (successful bidding (1)). The next (namely, second) bid price calculation processing is performed in response to the successful bidding (1) and again a bid is submitted (bidding (2)). The bidding management section 103 also performs successful bid processing for the bidding (2) and determines a successful bidder (successful bidding (2)). Further, again a bid is submitted (bidding (3)) following the successful bidding (2), and successful bid processing is performed. At the first time and the second time, abort notification described later is not output from the round repetition management section 107 to the successful bidder determination section 106.

Thus, successful bid processing for one bid is counted as one round and when a bid is input or the bidding result is output, the round repetition management section 107 increments the number of rounds by one to count the number of rounds.

When the number of rounds reaches a predetermined number, the round repetition management section 107 detects that the number of rounds reaches the predetermined number. The detection result is sent to the successful bidder determination section 106 as continuation notification. The successful bidder determination section 106 sends continuation notification information to the resource bidding section 102. Upon reception of the continuation notification information, the bid price calculation section 104 does not again perform bid price calculation and writes the final bid price of the bidding result information and QoS into the final bid price storage section 105.

The QoS is first read from the final bid price storage section 105 also storing QoS and may be changed in the later round. The QoS in the last round is written into the final bid price storage section 105.

Thus, bids are not submitted exceeding the predetermined number of rounds as the bidding processing continuation condition, so that the resource management apparatus of the embodiment can surely terminate bidding processing within a predetermined time.

(b) Processing Unit Time

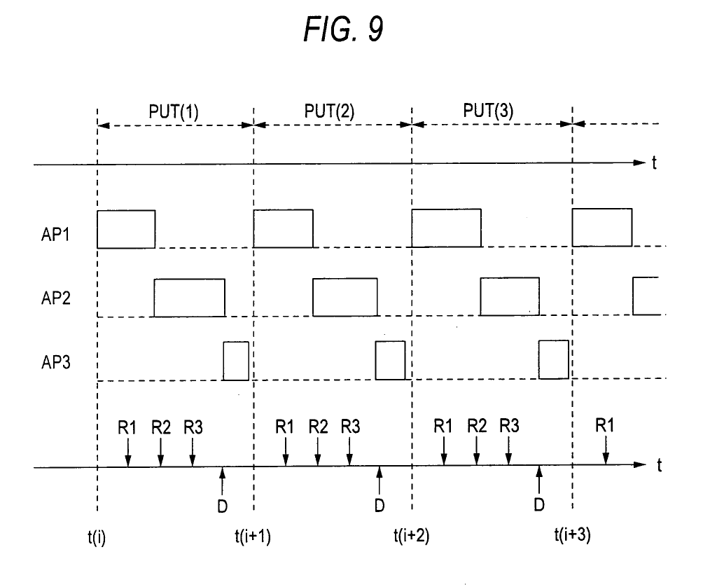

Next, the processing unit time will be discussed. Here, the processing unit time is the execution time of each application. FIG. 9 is a drawing to describe the processing unit time. It shows the case where the three applications of the node 2 (the radar signal processing application 43, the sonar signal processing application 44, and the radar information display application 45) are executed. FIG. 9 shows that three applications AP1, AP2, and AP3 are executed only for the time responsive to the CPU usage rate of the resource allocated for each processing unit time.

For each processing unit time, resource allocation for each application in the next processing unit time is determined by bidding. A bid is submitted a predetermined number of times as described above in processing unit time (PUT1) from time t(i) to time t (i+1) and finally a successful bidder is determined. In the embodiment, the predetermined number of times is three. Each application is executed only in the allocated CPU usage rate in response to the determined bidding result. In FIG. 9, the CPU usage rate of each application in processing unit time (PUT2) from time t(i+1) to time t (i+2) is determined in bidding processing in the processing unit time (PUT1).

In FIG. 9, after the first bid (R1) is submitted, the second bid (R2) is submitted and then the third bid (R3) is submitted. After the three bids are submitted, the successful bid is determined finally at the timing D. Each application is executed only in the allocated CPU usage rate in the next processing unit time in response to the bidding result.

Likewise, the CPU usage rate of each application in processing unit time (PUT3) is determined in bidding processing in the processing unit time (PUT2). Likewise, the CPU usage rate allocated to each application in the next processing unit time is determined by bidding in the processing unit time preceding the processing unit time.

(c) Successful Bidder Determination Section

In the bidding management section 103 receiving bidding information, the successful bidder determination section 106 determines which application makes a successful bid for the resource.

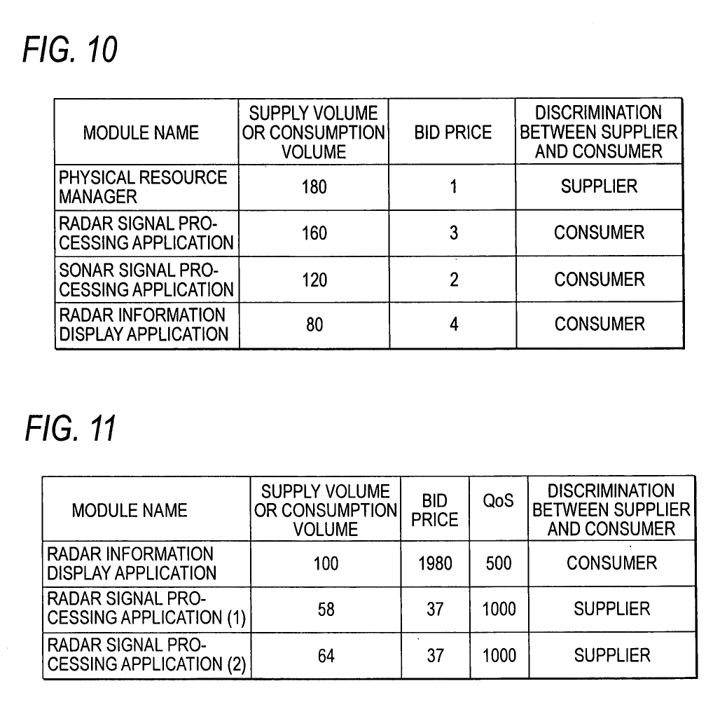

The operation of the successful bidder determination section 106 will be discussed by taking as an example the case where the bidding management section 42b of the physical resource manager 42 of the node 2 submits a bid for the descriptions shown in FIG. 10. FIG. 10 is a drawing to show an example of bidding information of physical resource.

The bidding information contains information of the module name, the supply volume or the consumption volume, the bid price, and discrimination between supplier and consumer. The module name indicates each processing section and can be represented not only by a character string as in FIG. 10, but also by a numeric value such as the process number. As the supply volume or the consumption volume, how much the resource is to be consumed or supplied is specified in the quantity in the unit defined for each resource. In FIG. 10, the CPU usage rate is specified inpercentage. As the bid price of the bid price, the price of the resource to be consumed or supplied is specified in virtual currency. The specification may be indicated in the unit price for each resource unit or may be indicated in the total amount (unit price multiplied by quantity). In FIG. 10, it is indicated in the unit price for each unit use rate.

In the embodiment, QoS is applied to data as the resource and is not applied to the CPU usage rate. Therefore, the bidding information handled by the bidding management section of the physical resource manager is as shown in FIG. 10; FIG. 10 may be like FIG. 11 by handling QoS shown in FIG. 11 as a fixed value.

The operation of the successful bidder determination section 106 is as follows:

First, for one supplier and two or more consumers like the CPU usage rate, namely, for the bidding management section 42b of the physical resource manager 42 in the embodiment, the operation of the successful bidder determination section 106 will be discussed. In this case, for bids from the consumers, the resources are allocated until the supply volume runs out in the descending order of the bid prices or until the bid price from the consumer falls below the bid price from the supplier.

The contract price at the time is the maximum bid price of the bid prices from the consumers to which the resource satisfying all the bid volume is not allocated or the bid price from the supplier, whichever is higher.

By way of example, if a bid shown in FIG. 10 is submitted, 180% of the supply volume from the physical resource manager is allocated to the consumption volume of each application. In this case, first, use rate 80% is allocated to the radar information display application 45 in the descending order of bid prices. Next, the remaining supply volume 100% is allocated to 160% of the radar signal processing application 43. The contract price becomes “3” because the bid price “3” of the radar signal processing application 43 (to which the resource satisfying all the bid volume 160% is not allocated) is higher than the bid price “0” of the physical resource manager.

Next, the operation of the successful bidder determination section 106 will be discussed by taking as an example the case where the bidding management section 45b of the radar information display application 45 of the node 2 submits a bid for the descriptions shown in FIG. 11. FIG. 11 is a drawing to show an example of bidding information of data. The bidding information in FIG. 11 contains information of QoS in addition to information of the module name, the supply volume or the consumption volume, the bid price, and discrimination between supplier and consumer.

The reason why the consumption volume of the radar information display application 45 is “100” in FIG. 11 is that the radar information display application 45 cannot perform display processing unless it receives 100% data. The supply volume of the radar signal processing application 43 of the node 2 is “58,” which means that the maximum value of percentage (%) in which the radar signal processing application 43 can process and supply radar information is “58.” The maximum value “58” is a value determined from the CPU usage rate allocated to the radar signal processing application 43 in the node 2; it is a setup value meaning that the radar signal processing application 43 may process 58% of radar information 100%. Likewise, the supply volume of the radar signal processing application 53 of the node 3 is “64,” which means that the maximum value of percentage (%) in which the radar signal processing application 53 can process and supply radar information is “64.” The maximum value “64” is a value determined from the CPU usage rate allocated to the radar signal processing application 53 in the node 3; it is a setup value meaning that the radar signal processing application 53 may process 64% of radar information 100%. “500” of QoS of the radar information display application 45 means that the minimum value, namely, the allowed limit value is “500” as for the radar information display application 45. Both QoS of the radar signal processing application 43 of the node 2 and QoS of the radar signal processing application 53 of the node 3 are “1000,” which means that the maximum value of QoS is “1000.”

For the maximum value “1000” of QoS, the radar information display application 45 cannot perform display processing unless it receives data of consumption volume “100;” however, if QoS lowers, the consumption volume becomes lower than “100” in response to the QoS and consequently the CPU usage rate also lowers in response to the decrease in the consumption volume.

The bid price of the radar information display application 45 is “1980,” which means that the maximum value of the bid price of the radar information display application 45 is “1980.” Both of the bid prices of the radar signal processing application 43 of the node 2 and the radar signal processing application 53 of the node 3 are “37,” which means that the minimum value of the bid price is “37.”

Here, since the bid price is the unit price for each unit use rate of the CPU usage rate, when a comparison is made between the bid prices in the greater-than, equal-to, less-than relation, the CPU usage rate need not be considered. However, to submit a bid with the total amount as the bid price, the successful bidder determination section 106 needs to calculate the unit price by dividing the bid price by the CPU usage rate and compare the unit prices to determine a successful bidder.

In FIG. 11, for bids from the suppliers, the resources are allocated until the supply volume runs out in the ascending order of the bid prices or until the bid price from the supplier exceeds the bid price from the consumer, as described later. However, a bid where QoS of bidding from the supplier falls below QoS of bidding from the consumer does not become a successful bid.

If the producer or the consumer makes a successful bid for only a part of the resource consumed by the producer or the consumer, the producer or the consumer cancels the resource being contracted by the producer or the consumer, as described above. In this case, the next highest bidder contracts the bid for the resource.

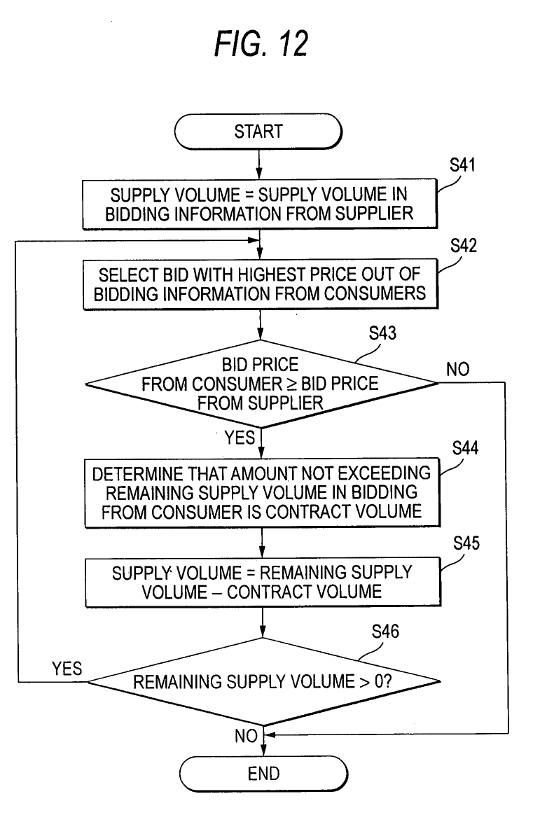

FIG. 12 is a flowchart to show an example of a processing flow of the successful bidder determination section 106 of the physical resource manager of a supplier. Here, the processing in the node 2 will be discussed.

First, the successful bidder determination section 106 adopts the supply volume determined by the supplier, namely, the supply volume in bidding information of the supplier as the supply volume (step S41).

The successful bidder determination section 106 selects the bid with the highest price out of the bidding information from the consumers of the resources (step S42). In the example in FIG. 10, the radar information display application 45 is selected.

The successful bidder determination section 106 determines whether or not the bid price from the consumer is equal to or greater than the bid price from the supplier (step S43). In FIG. 10, the bid price of the physical resource manager 42 of the supplier is “1” and the radar information display application 45 of the consumer is “4” and therefore YES is returned at step S43 and the process goes to step S44.

When the successful bidder determination section 106 determines that the bid price from the consumer is less than the bid price from the supplier, NO is returned at step S43 and the processing is terminated.

At step S44, the successful bidder determination section 106 determines that the amount not exceeding the remaining supply volume in the bidding from the consumer is the contract volume. In FIG. 10, the consumption volume 80 of the radar information display application 45 can be subtracted from the supply volume 180 and therefore the consumption volume 80 of an amount not exceeding the supply volume is determined the contract volume.

Next, the successful bidder determination section 106 calculates the remaining supply volume, namely, calculates the remaining supply volume by subtracting the contract volume from the remaining supply volume (step S45). In FIG. 10, the contract volume 80 is subtracted from the supply volume 180 to find the remaining supply volume 100.

The successful bidder determination section 106 determines whether or not the remaining supply volume is more than 0 (step S46).

When the remaining supply volume exceeds 0, YES is returned at step S46 and the process returns to step S42. When the remaining supply volume is 0 or less, NO is returned at step S46 and the processing is terminated.

At step S42, steps S42 to S46 described above are repeated for bidding from any other consumer than the successful bidder.

The described processing of steps S41 to S46 is repeated a predetermined number of times (here, three times). The processing of steps S41 to S46 corresponds to one round.

As described above, if a plurality of application programs contain a plurality of resource consumption programs for consuming the resources, the bidding management section 103 performs resource allocation processing so as to allocate the resources to the resource consumption program with a larger bid price taking precedence over other resource consumption programs.

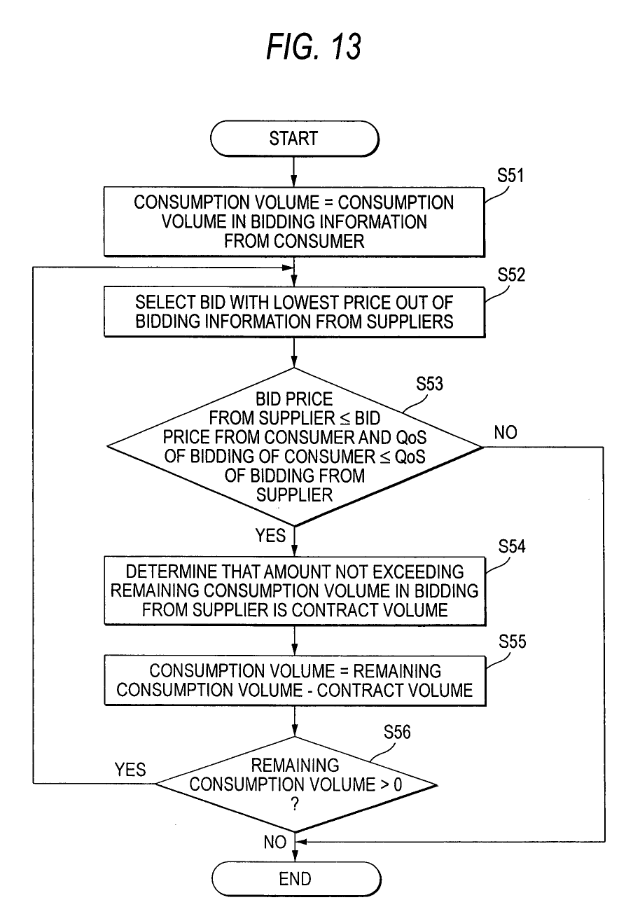

On the other hand, for two or more suppliers and one consumer like the sensor information, namely, for the bidding management section 45b of the radar information display application 45 in the embodiment, as the operation of the successful bidder determination section 106, “supply” may be replaced with “consumption” and “high” may be replaced with “low” in FIG. 12. FIG. 13 is a flowchart to show an example of a processing flow of the successful bidder determination section 106 of the information display application.

First, the successful bidder determination section 106 adopts the consumption volume determined by the consumer, namely, the consumption volume in bidding information of the consumer as the consumption volume (step S51)

The successful bidder determination section 106 selects the bid with the lowest price out of the bidding information from the suppliers of the resources (step S52). In the example in FIG. 11, the bid prices of the radar signal processing application 43 of the node 2 and the radar signal processing application 53 of the node 3 are the same, namely, “37” and therefore, for example, these two applications are previously assigned the priority, whereby either of the two applications is selected. For example, the radar signal processing application 43 is selected.

The successful bidder determination section 106 determines whether or not the bid price from the supplier is equal to or less than the bid price from the consumer and whether or not QoS of the bidding of the supplier is equal to or greater than QoS of the bidding of the consumer (step S53). In FIG. 11, the bid price of the radar information display application 45 of the consumer is “1980” which is more than “37” and QoS of the bidding of the radar information display application 45 is “1000” which is more than “500” and therefore YES is returned at step S53 and the process goes to step S54.

When the successful bidder determination section 106 determines that the bid price from the supplier exceeds the bid price from the consumer, NO is returned at step S53 and the processing is terminated.

At step 54, the successful bidder determination section 106 determines that the amount not exceeding the remaining consumption volume in the bidding from the supplier is the contract volume. In FIG. 11, the supply volume “58” can be subtracted from the consumption volume “100” of the radar information display application 45 and therefore the supply volume “58” of an amount not exceeding the consumption volume is determined the contract volume.

Next, the successful bidder determination section 106 calculates the remaining consumption volume, namely, calculates the remaining consumption volume by subtracting the contract volume from the remaining consumption volume (step S55). In FIG. 11, the contract volume 58 is subtracted from the remaining consumption volume 100 to find the remaining consumption volume 42.

The successful bidder determination section 106 determines whether or not the remaining consumption volume is more than 0 (step S56).

When the remaining consumption volume exceeds 0, YES is returned at step S56 and the process returns to step S52. When the remaining consumption volume is 0 or less, NO is returned at step S56 and the processing is terminated.

At step S52, steps S52 to S56 described above are repeated for bidding from any other supplier than the successful bidder.

As described above, successful bidder determination processing is performed provided that the bid price does not exceed the upper limit value and that QoS is equal to or greater than the allowed limit value at step S53.

The described processing of steps S51 to S56 is repeated a predetermined number of times (here, three times). The processing of steps S51 to S56 corresponds to one round.

The number of repetitions is also previously determined and is 3 in the embodiment.

As described above, if a plurality of application programs contain a plurality of resource supply programs for supplying the resources, the bidding management section 103 performs resource allocation processing so as to allocate the resources to the resource supply program with a smaller bid price taking precedence over other resource supply programs.

(d) Round Repetition Management Section

The round repetition management section 107 counts the number of times the processing previously described with reference to FIGS. 12 and 13 has been executed, and controls execution of the above-described processing of the successful bidder determination section 106 so that the processing in FIGS. 12 and 13 is not executed exceeding the predetermined number of times.

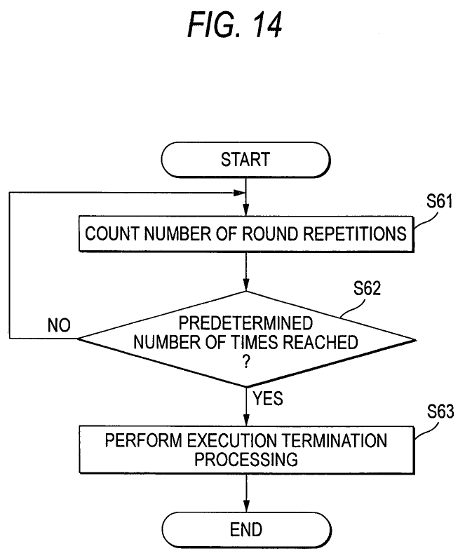

FIG. 14 is a flowchart to show an example of a processing flow of the round repetition management section 107. The round repetition management section 107 counts the number of round repetitions described above (step S61) The round repetition management section 107 determines whether or not the counted number of round repetitions has become the predetermined number of times, three in the embodiment (step S62). If the counted number of round repetitions does not reach the predetermined number of times, NO is returned at step S62 and the process returns to step S61. When the counted number of round repetitions has become the predetermined number of times, the round repetition management section 107 performs execution termination processing of terminating the processing in FIGS. 12 and 13 (step S63). In the execution termination processing, the above-described abort notification is output to the resource bidding section 102 together with or aside from the successful bid information.

Thus, the round repetition management section 107 stores the number of rounds, increments the number of rounds by one each time a round is executed, and aborts, namely, terminates processing so as not to execute any more round if the counted number of rounds reaches the upper limit, namely, the predetermined number of times. The application creator may describe the upper limit value in the source code of the application or the user may directly or indirectly specify the upper limit value through the terminal.

As the processing is aborted, it is guaranteed that the bidding always terminates within a given time period. When notification of the bidding result is sent to the processing section submitting the bit, notification as to whether or not the rounds have reached the end is sent as additional information.

In the example described above, the number of round repetitions is incremented by one and whether or not the number of round repetitions has become the predetermined number of times is determined. However, the number of round repetitions may be managed by decrementing the predetermined number of times by one each time a round is executed and determining whether or not the predetermined number has become 0.

### 5. Operation of Whole Apparatus

In the resource management apparatus as described above, the parameters of the predetermined amount, etc., incremented or decremented in the bid price calculation section 104 are appropriately set, whereby finally it is made possible for the radar information display application of the node 2 to receive radar information from the radar signal processing application of the node 3 and operate according to the received radar information.

FIGS. 15 and 16 are tables to show the bidding and successful bid situation of the resource management apparatus in the embodiment up to the number of rounds “20.” FIGS. 15 and 16 show examples of data of bid prices, etc., in 20 successive rounds. Since the number of round repetitions described above is “3,” rounds 1 to 3 indicate the progress and the result of the first bidding processing and rounds 4 to 6 indicate the progress and the result of the second bidding processing. Likewise, bidding processing is performed in the processing unit time in three rounds.

As described above, FIGS. 15 and 16 show an example wherein processing is performed under the conditions that the radar signal processing application needs CPU usage rate 135% to generate 100% radar information, the sonar signal processing application needs CPU usage rate 90% to generate 100% sonar information, the radar information display application needs CPU usage rate 90% to process 100% radar information, and the sonar information display application needs CPU usage rate 35% to process 100% sonar information in the relationship between supply and consumption of the resources. The minute amount to increase or decrease the value when each bid price is calculated is “4” for the bid price and is “3” for the bid volume. In the bidding, each bidding participant submits a bid for four types of resources of the CPU usage rates of the nodes 2 and 3, radar information, and sonar information, and the contract volume and the contract price are determined.

In FIGS. 15 and 16, the resources are appropriately allocated in the 20th round and later. Seeing the result of the 20th round, in the node 2, the radar signal processing application generates radar information 58% in CPU usage rate 78% and the sonar signal processing application generates sonar information 37% in CPU usage rate 42%. In the node 3, the radar signal processing application generates radar information 42% in CPU usage rate 86% and the sonar signal processing application generates sonar information 63% in CPU usage rate 56%.

The allocation results satisfy the conditions that the radar signal processing application needs CPU usage rate 135% to generate 100% radar information and the sonar signal processing application needs CPU usage rate 90% to generate 100% sonar information. The allocation results also satisfy the conditions that the radar information display application needs CPU usage rate 60% and the sonar information display application needs CPU usage rate 35%. Further, the radar information display application makes a successful bid for 100% radar information and the sonar information display application makes a successful bid for 100% sonar information and thus the data required for displaying the radar information and the sonar information is provided without any problem. In the rounds preceding the 20th round, a certain measure of operation is possible, but the sufficient CPU usage rate is not allocated in some cases and thus it is feared that a state in which the real-time property of the whole apparatus is not satisfactory may occur. However, such a state occurs only in the initial bidding state and therefore no problem arises as a whole.

Since the radar information is more important than the sonar information in the embodiment, the upper limit value of the bid price is set so that radar signal processing and radar information display are executed taking precedence over sonar signal processing and sonar information display. In the above-described example, the upper limit value of the purchase price is made different between the two sensor information display applications and each of the sensor information display applications buys the resource consumed by the display application within the range to the upper limit value and operates. If setting of the upper limit value can be changed in response to the situation, it is made possible to change the importance of each application.

Since the bid price of the CPU usage rate of the node 3 is lower than that of the node 2 where the CPU usage rate is being contracted by the radar information display application and the price of the CPU usage rate rises, the radar information processing application of the node 3 presents a lower bid price (sell price) of radar information as resource than the radar information processing application of the node 2 and thus the radar information display application 45 buys the radar information from the radar information processing application 53 of the node 3 and the radar information processing application of the node 3 operates.

Further, since the final bid price storage section 105 is provided in the resource bidding section 102, the bid price is calculated based on the preceding bidding result in bidding processing in the next processing unit time, so that a situation in which the time to convergence of an appropriate state is prolonged is circumvented.

That is, if the bidding processing is simply aborted, there is a fear of insufficient measures and thus bidding processing of a plurality of rounds is executed as described above. This is for gradually improving the resource allocation efficiency, but a small number of rounds would lead to insufficient improvement. In such a case, resource allocation in bidding for each processing unit time is inefficient, namely, a state in which resource allocation correctly considering the importance of signal processing, etc., in the phase is impossible will continue. In such a case, if the final bid price storage section is not provided, the bid prices of the producer and the consumer start at 0 every time for each processing unit time and a large number of rounds (20 rounds or more in the above-described case) must be executed until convergence to an appropriate state. Thus, in the embodiment, the final bid price storage section stores the preceding bid price so that if processing is aborted by the round repetition management section, for example, in five rounds, to guarantee termination of bidding within a given time, the state converges to an appropriate allocation state through four processing unit times, for example, as described above.

Although the round abort condition is the number of repetitions in the embodiment described above, as a modified example, the round repetition management section may measure the round execution time rather than the number of rounds and may abort round processing if the round execution time reaches a predetermined time.

The application creator may describe the predetermined time in the source code of the application or the user may directly or indirectly specify the predetermined time through the terminal. Alternatively, as a round abort method based on time measurement, a timer may be set using a timer function provided by the OS at the first round time and notification of the expiration of the setup time may be provided for aborting.

A method of reading a real-time clock of the OS at the first round time, storing the time in the round repetition management section, calculating the difference between the current time and the stored time in each round, and determining whether or not a given time has elapsed is also possible.

In the embodiment described above, for simplicity of the description, it is assumed that the sensor information system 1 is a system including the two nodes 2 and 3, but may contain three or more nodes. The radar 25 and the sonar unit 35 for outputting a sensor signal are connected to the nodes 2 and 3 respectively, but the system may be configured so that a plurality of units each for outputting a sensor signal are connected to one node. That is, there may be some nodes to which a unit for outputting a sensor signal is not connected and one node to which a plurality of units each for outputting a sensor signal are connected.

Further, in the embodiment described above, each node is provided with two CPUs, but may be provided with one or three or more CPUs, and one or more CPUs are connected to other circuits by an internal bus of each node.

As described above, according to the embodiment of the invention, when resource allocation based on the market mechanism of the bidding manner is conducted in the sensor information system 1, QoS of data of the signal processing application and the information display application of applications capable of adapting to QoS is adjusted, whereby the resource consumption volumes of the applications are adjusted as a result. Consequently, an application whose user value is relatively low or the application of a producer with an application whose user value is relatively low as a consumer can also operate as much as possible.

Consequently, for example, each signal processing application operates with QoS matching the available CPU usage rate and thus execution of an application whose user value is low (in the example in FIG. 10, sonar signal processing application) is aborted only if the available CPU usage rate lowers to such an extent that it cannot be handled with QoS adaptation to each application because of hardware fault, abnormal overload, etc. Therefore, the QoS adaptation is considered in the bidding manner, whereby the occasions of execution of even an application whose user value is low increase and convenience of the user improves.

According to the embodiment described above, in a real-time system based on advanced bidding such as supply chain bidding, round processing in bidding of a plurality of rounds is aborted according to the condition of the number of times or the time, whereby resource allocation can be realized while the real-time property of bidding is ensured. That is, the resource management apparatus of the embodiment described above can execute the corresponding application while ensuring the real-time property in response to the importance of data.

The final bid price in the bidding in the preceding processing unit time is recorded and is used as the initial value of bidding in the next processing unit time, whereby the bid price approaches to the bid price of a plurality of rounds not aborted in a long term.

The “sections” in the Specification are conceptual corresponding to the functions of the embodiment and are not necessarily provided in a one-to-one correspondence with specific hardware units or software routines. Therefore, in the Specification, the embodiment is described assuming virtual circuit blocks (sections) having the functions of the embodiment. The steps of the procedures in the embodiment may be changed in the execution order and may be executed simultaneously or may be executed in a different order for each execution unless the nature is violated.

Further, all or a part of the program for executing the operation described above is recorded or stored on a portable medium of a floppy (registered trademark) disk, a CD-ROM, etc., in storage of a hard disk, etc. The program is read by a computer and all or a part of the operation is executed. Alternatively, all or a part of the program can be distributed or provided through a communication network. The user can download the program through a communication network and can install the program in a computer or can install the program in a computer from a record medium recording or storing the program, thereby easily implementing the resource management apparatus of the invention.

It is to be understood that the present invention is not limited to the above-described specific embodiment thereof and various changes, modifications, etc., may be made without departing from the spirit and the scope of the invention.

What is claimed is:

1. A resource management apparatus comprising:
a storage that stores quality parameters being set for each of a plurality of application programs respectively, each of the quality parameters indicating a quality of a resource to be consumed or supplied by each of the application programs within a predetermined unit time;
a plurality of resource bidders that are provided for each of the plurality of application programs respectively, each of the resource bidders including:
a generation part that generates a bid price of the resource to be consumed or supplied in response to a volume of the resource to be consumed or supplied;
and
an update part that changes the bid price of the resource to be consumed or supplied using information of the quality parameter being adjusted to decrement by a first predetermined amount when each of the application programs is not allocated with a necessary volume of the resource for executing the application program, and to increment by a second predetermined amount when each of the application programs is allocated with the necessary volume of the resource for executing the application program;
a parameter updater that updates the quality parameter stored in the storage to the adjusted quality parameter when the quality parameter is decremented by the first predetermined value or is incremented by the second predetermined value; and
a bidding manager that performs resource allocation processing for allocating the resource to each of the application programs in the predetermined unit time using the bid prices generated by each of the resource bidders.

2. The resource management apparatus according to claim 1, wherein the application programs includes:
a program for processing a radar signal from a radar;
a program for displaying radar information based on the radar signal;
a program for processing a sonar signal from a sonar unit; and
a program for displaying sonar information based on the sonar signal.

3. The resource management apparatus according to claim 2, wherein the quality parameters include a resolution of image data based on the radar signal and the sonar signal.

4. The resource management apparatus according to claim 1, wherein the bidding manager performs the resource allocation processing when conditions of:
(1) a bid price generated by an application program that supplies the resource is equal to or less than a bid price generated by an application program that consumes the resource; and
(2) a quality parameter set for the application program that consumes the resource is equal to or less than a quality parameter set for the application program that supplies the resource are both satisfied.

5. A computer readable medium storing a program causing a computer to execute a process for managing resources to be consumed or supplied by each of a plurality of application programs, the process comprising:
generating a bid price of a resource to be consumed or supplied by each of the application programs within a predetermined unit time in response to a volume of the resource to be consumed or supplied, for each of the application programs;
changing the bid price of the resource to be consumed or supplied using information of a quality parameter that indicating the quality of the resource to be consumed or supplied by each of the application programs, the quality parameter being adjusted to decrement by a first predetermined amount when each of the application programs is not allocated with a necessary volume of the resource for executing the application program, and to increment by a second predetermined amount when each of the application programs is allocated with the necessary volume of the resource for executing the application program;
updating the quality parameter to the adjusted quality parameter when the quality parameter is decremented by the first predetermined value or is incremented by the second predetermined value; and
performing resource allocation processing for allocating the resources to each of the application programs in the predetermined unit time using the bid prices generated for each of the application programs.

6. An information processing apparatus for managing resources to be consumed or supplied by each of a plurality of application programs, the apparatus comprising:
a memory that stores quality parameters being set for each of a plurality of application programs respectively, each of the quality parameters indicating a quality of a resource to be consumed or supplied by each of the application programs within a predetermined unit time; and
a processor that is operable to perform a process comprising:
generating a bid price of the resource to be consumed or supplied in response to a volume of the resource to be consumed or supplied, for each of the application programs;
changing the bid price of the resource to be consumed or supplied using information of the quality parameter being adjusted to decrement by a first predetermined amount when each of the application programs is not allocated with a necessary volume of the resource for executing the application program, and to increment by a second predetermined amount when each of the application programs is allocated with the necessary volume of the resource for executing the application program;
updating the quality parameter to the adjusted quality parameter when the quality parameter is decremented by the first predetermined value or is incremented by the second predetermined value; and
performing resource allocation processing for allocating the resources to each of the application programs in the predetermined unit time using the bid prices generated for each of the application programs.
